(19) United States
(12) Patent Application Publication
(10) Pub. No.: US 2026/0087285 A1
(43) Pub. Date: Mar. 26, 2026

(54) Dual PCB Green Laser Engine Layout

(71) Applicant: ZEBRA TECHNOLOGIES CORPORATION, Lincolnshire, IL (US)

(72) Inventors: Alexander J. Naney, Kings Park, NY (US); Mark D. Anderson, Dix Hills, NY (US)

(21) Appl. No.: 18/895,266

(22) Filed: Sep. 24, 2024

(51) Int. Cl. G06K 7/10

(52) U.S. Cl. CPC G06K 7/10732; G06K 7/10831; G06K 7/10851; G06K 7/1092

(57) ABSTRACT

A scan engine for capturing images of an object appearing in an imaging field of view (FOV) includes a chassis including a chassis body defining at least one confined volume having a chassis mounting portion, a first board operably coupled with the chassis mounting portion, a second board, an imaging assembly, and an aiming assembly. The first board includes a first board. The second board includes a second board connector adapted to couple with the first board connector. The imaging assembly includes an imaging sensor adapted to capture the at least one image. The aiming assembly generates an aiming pattern to assist with identifying the FOV and includes a laser diode at least partially disposed within the confined volume. The imaging system is electrically coupled with the first board, and the laser diode is electrically coupled with the second board.

### BACKGROUND

Industrial scanners and/or barcode readers may be used in warehouse environments and/or other environments and may be provided in the form of mobile scanning devices. These scanners may be used to scan barcodes and other objects. Such scanners are typically contained within a chassis to ensure optical components are protected from bumps, falls, and/or other potentially damaging events. In some environments, high powered scanners capable of scanning or resolving barcodes (e.g., 100 ml wide) across a wide range of distances, such as from inches to tens of feet, or more, may be desirable. These scanners also must operate over a range of field of views (FOVs) and often require illumination assemblies and aiming pattern systems. Often, such systems do not provide effective illumination and/or aiming over the entire range of wide FOVs needed for operation.

Some aiming pattern systems may be provided having different color lasers such as, for example, red or green. In some arrangements, green aiming patterns may be desirable due to their relatively increased brightness and ease of visualization, in addition to better eye response by the user. Further, in some examples, aiming pattern systems incorporating red lasers may be difficult to visualize across further distances. However, aiming pattern systems incorporating green lasers may require additional electrical components to properly drive such systems. Additionally, such systems may require larger optics in order to meet performance requirements, but there remains a compromise between the lens systems and optics having a specific size while being constrained by the overall dimensions of the scanner housing and/or chassis. In some arrangements, green aiming patterns may be more difficult to drive due to increased power requirements, and may require the implementation of single point faults to adhere with safety protocols. These additional components may occupy a significant footprint on the circuit board, which may present challenges due to the chassis and housing having fixed dimensional requirements.

Accordingly, there is a need for improved accessories having improved functionalities.

### SUMMARY

Scan engines are disclosed herein. A scan engine for capturing images of an object appearing in an imaging field of view (FOV) includes a chassis including a chassis body defining at least one confined volume having a chassis mounting portion, a first board operably coupled with the chassis mounting portion, a second board, an imaging assembly, and an aiming assembly. The first board includes a first board connector. The second board includes a second board connector adapted to couple with the first board connector. The imaging assembly includes an imaging sensor adapted to capture the at least one image and is at least partially disposed within the confined volume. The aiming assembly generates an aiming pattern to assist with identifying the FOV and includes a laser diode at least partially disposed within the confined volume. The imaging system is electrically coupled with the first board, and the laser diode is electrically coupled with the second board.

In some examples, the second board is adapted to physically couple with the first board in a stacking arrangement. In some forms, the aiming assembly further includes a laser drive circuit disposed on the second board, and the laser drive circuit may electrically couple with the laser diode. Further, in some arrangements, the laser diode includes at least one lead extending therefrom that electrically couples with the laser drive circuit. Further, in some forms, the at least one lead is adapted to extend through at least one opening formed on the first board.

In these and other forms, the scan engine may further include an illumination assembly. Further, the at least one scan engine may include a processor disposed on the first board that controls operation of the imaging assembly and further sends a control signal to the second board via the first board connector to control operation of the aiming assembly.

In some approaches, the second board further includes a second board-to-host connector adapted to electrically couple with a host controller. In some examples, the second board further includes support circuitry adapted to control operation of the aiming assembly.

In accordance with a second aspect, a scan engine for capturing at least one image of an object appearing in an imaging field of view (FOV) includes a chassis including a chassis body defining at least one confined volume, the chassis body including a chassis mounting portion, a first board having a first side and a second side, the first side being operably coupled with the chassis, the first board including a first board connector disposed on the second side thereof, a second board having a first side and a second side, the second board including a second board connector disposed on the first side thereof adapted to electrically couple with the first board connector of the first board, an imaging assembly including an imaging sensor adapted to capture the at least one image of the object appearing in the imaging FOV, the imaging assembly being at least partially disposed within the at least one confined volume of the chassis body, the imaging sensor being electrically coupled with the first board, and an aiming assembly adapted to generate an aiming pattern to assist with identifying the FOV. The aiming assembly includes a laser diode extending along a longitudinal axis in a first direction and being at least partially disposed within the at least one confined volume of the chassis body. The laser diode is electrically coupled with the second board.

In accordance with a third aspect, a scan engine for capturing at least one image of an object appearing in an imaging field of view (FOV) includes a chassis including a chassis body defining at least one confined volume, the chassis body including a chassis mounting portion, a second board including a second board connector adapted to be alternatively connected with: 1) a first primary board having a first imaging sensor coupled therewith; and 2) a second primary board having a second imaging sensor coupled therewith, the first imaging sensor having a different configuration than the second imaging sensor.

In accordance with a fourth aspect, a scan engine for capturing at least one image of an object appearing in an imaging field of view (FOV) includes a chassis including a chassis body defining at least one confined volume, the chassis body including a chassis mounting portion, and a first board coupled with the chassis at the chassis mounting portion, the first board including an imaging system at least partially disposed within the chassis body and coupled with the first board, the imaging system adapted to capture at least one image of an object appearing in the FOV of the device. The first circuit board is alternatively couplable with: 1) a first secondary board having a first laser diode and first laser drive circuit electrically coupled therewith, the first laser diode outputting a first wavelength of light; and 2) a second secondary board having a second laser diode and second laser drive circuit electrically coupled therewith, the second laser diode outputting a second wavelength of light.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of an example scan engine for capturing images of an object in accordance with various embodiments;

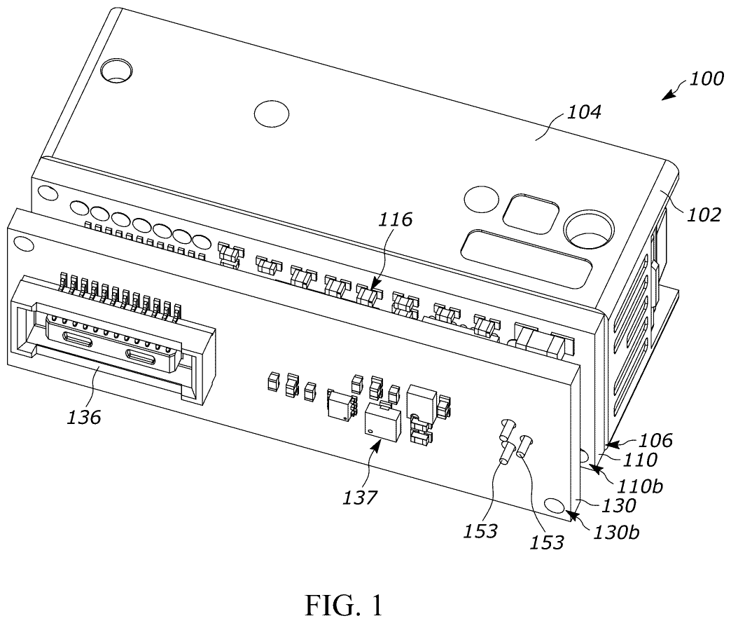

FIG. 2 illustrates a front elevation view of the example scan engine of FIG. 1 for capturing images of an object in accordance with various embodiments;

FIG. 3 illustrates a top plan view of the example scan engine of FIGS. 1 and 2 in accordance with various embodiments;

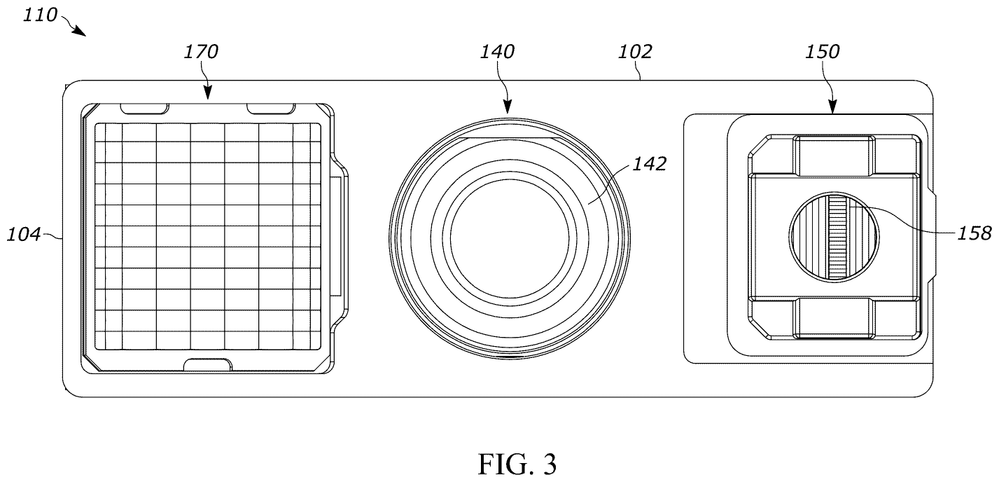

FIG. 4 illustrates a front elevation cross-sectional view of the example scan engine of FIGS. 1-3 in accordance with various embodiments;

FIG. 5 illustrates an example front elevation schematic view of the example scan engine of FIGS. 1-4 in accordance with various embodiments.

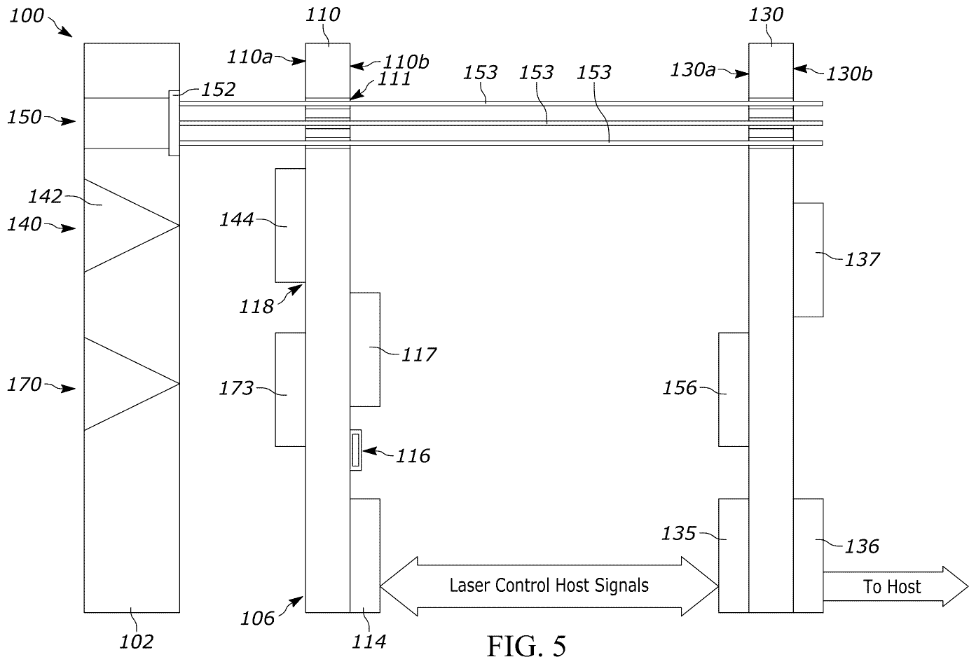

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to these various embodiments, a compact high-performance scan engine for use with handheld scanners is provided that remains disposed within dimensional requirements of existing handheld scanners. More specifically, the scan engines described herein may incorporate high powered aiming pattern systems capable of emitting green light, which may provide improved visibility across extended distances while making use of available height within the scanner housing. Notably, a second circuit board is provided that is electrically coupled with the aiming assembly, whereas additional components of the scan engine (e.g., an imaging assembly, an illumination assembly, and the like) may be electrically coupled with a first circuit board. The first and second circuit boards may themselves be communicatively coupled with each other, and may be arranged in a generally stacked configuration. As such, the scan engines described herein provide greater freedom in terms of circuit design and real estate used to implement the aiming assembly and components thereof. The scanner may therefore incorporate larger, higher-powered aiming assemblys capable of providing visual indicators on barcodes disposed at greater distances, and greater ranges of distances, from the scanner.

Turning to the figures, an assembly or scan engine 100 for capturing at least one image of an object appearing in an imaging field of view (FOV) is provided. The scan engine 100 includes a chassis 102 having a chassis body 104 defining at least one cavity or confined volume 104a for containing one or more components for performing imaging of an object or target in a FOV. The chassis 102 further includes a chassis mounting portion 106. In examples, the chassis 102 may be constructed from a plastic material or a metal material as desired (e.g., to reduce overall scan engine weight or to perform as a heat sink for electrical components, optical components, lasers, illumination sources, and the like, respectively).

The scan engine 100 further includes a first board or circuit board 110 disposed adjacent to the chassis 102. The first circuit board 110 may have a first side 110a, a second side 110b, an opening 111 (or pass-through region) extending between the first and the second sides 110a, 110b, and may include any number of support circuitry 116 in the form of electrical and/or electro-mechanical components (e.g., controllers or processors 117, capacitors, resistors, transistors, power supplies, etc.) used to communicatively couple and/or control various electrical components of the scan engine 100. For example, the first circuit board 110 may include any number of component mounting portions 118, to allow components (e.g., imaging sensors, light emitting diodes, etc.) to operably couple therewith, and may additionally include one or more board mounts used to secure the first circuit board 110 with the chassis 102 at the chassis mounting portion 106. Such a coupling which may be in the form of a friction-fit coupling, a threaded coupling, a bracket member, and the like. Other examples are possible. Additionally, the first board 110 includes a first board connector 114 disposed on the second side 110b thereof which will be described in further detail below.

The assembly further includes a second board or circuit board 130 disposed adjacent to the second side 110b of the first board 110. The second circuit board 130 may have a first side 130a and a second side 130, and like the first board 110, may include any number of electrical and/or electro-mechanical components (e.g., capacitors, resistors, transistors, power supplies, etc.) used to communicatively couple and/or control various electrical components of the scan engine 100. For example, the second circuit board 130 may include any number of component mounting portions 138 to receive components (e.g., laser diodes, etc.) to operably couple therewith, and may additionally include a second board connector 135 disposed on the first side 130a thereof.

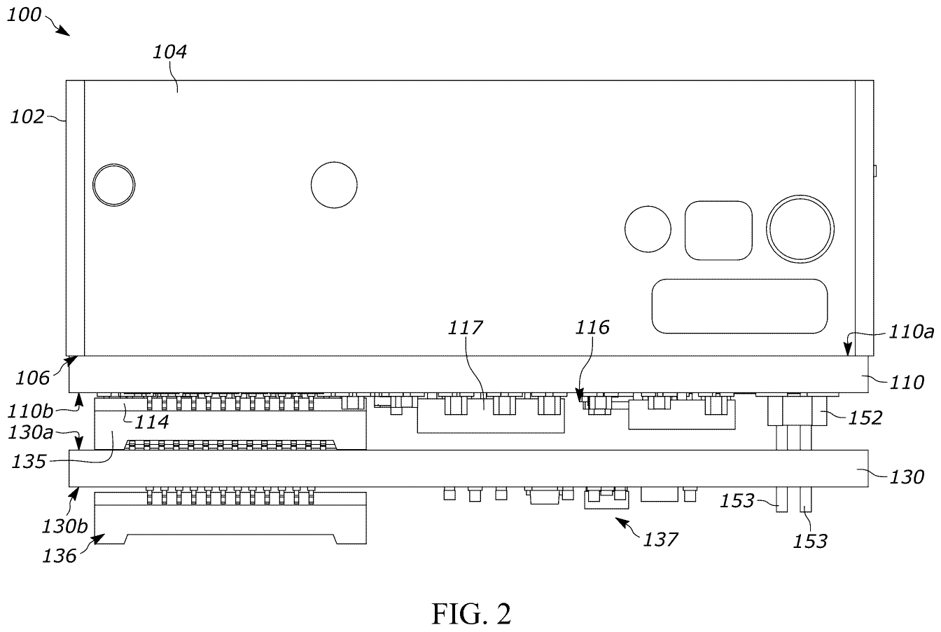

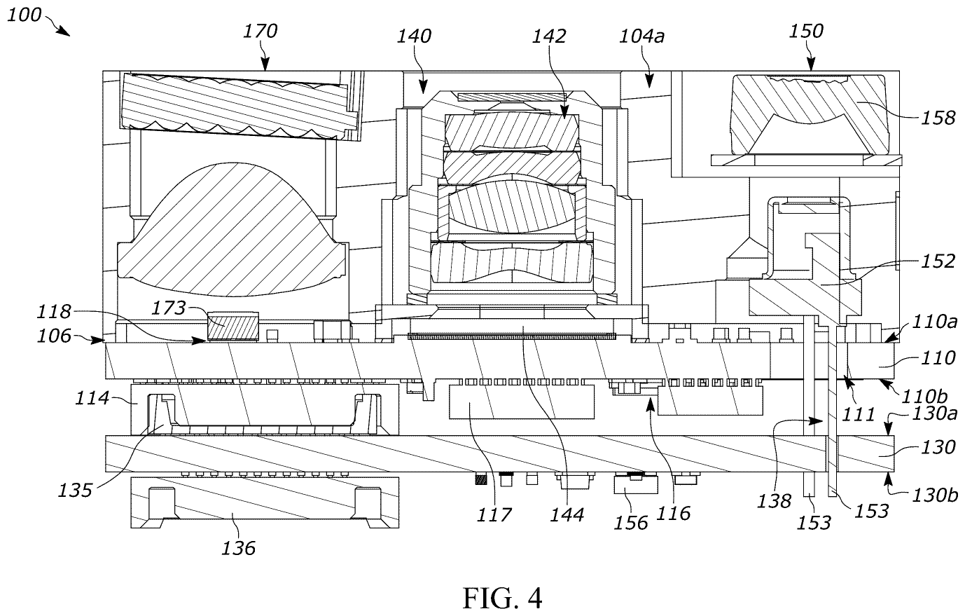

Notably, the first board 110 and the second board 130 are disposed in a “stacked” arrangement whereby the first and second boards 110, 130 occupy the same or nearly the same vertical footprint. As illustrated in FIGS. 2 and 4, the first board connector 114 may operably couple with the second board connector 135 to provide a physical and electrical coupling between the two boards 110, 130. More specifically, in some examples, each of the first board connector and the second board connector 135 may be in the form of corresponding board-to-board connectors that may either directly engage each other or be connected using a data cable or interconnect (not illustrated). It is to be appreciated that in some examples, any number of additional mounts or structural members (not illustrated) may be provided to secure the first and second boards 110, 130.

Further, while described as first and second boards 110, 130, in some implementations, the first and second boards 110, 130 may be part of a singular rigid-flexible circuit board. The rigid-flexible circuit board may include one or more substantially flexible portions that physically and electrically interconnect the first and second boards with each other, and with additional elements of the scan engine 100. In examples, the first and second boards may be substantially rigid portions of the rigid-flexible circuit board, and the flexible portions are malleable and bendable portions. The flexible portions of the rigid-flexible circuit board may reduce the number of additional wires and electrical interconnects in the scan engine 100 allowing for a simplified electrical structure and reduced overall size.

As previously noted, the scan engine 100 includes a number of components used to capture at least one image appearing in a FOV. More specifically, an imaging assembly 140 is provided that is at least partially disposed within the confined volume 104a of the chassis body 104. The imaging assembly 140 is operatively coupled to the first board 110 (via, for example, the component mounting portions 118) on the first side 110a thereof and is disposed to capture image objects in a FOV along an axis of the imaging assembly 140. The imaging assembly 140 may include any number of components such as, for example, imaging optics 142 and an imaging sensor 144 for capturing images in the FOV. The imaging optics 142 are disposed to receive light through an aperture of the chassis 102, and the imaging optics 142 further focus the light onto the imaging sensor 144.

As previously noted, in some examples, the imaging sensor 144 is mounted to or coupled with the first circuit board 110 via the component mounting portion 118 of the first circuit board 110. The component mounting portion 118 may include an adhesive to assist in physically securing the imaging sensor 144 to the circuit board 110. In other examples, the component mounting portion 118 may include any number of electrical interconnects that receive corresponding electrical interconnects disposed or otherwise coupled with the circuit board 110. Other examples are possible.

It is to be appreciated that while the various figures depict a single imaging assembly 140, in some examples, the scan engine 100 may be equipped with multiple imaging assemblies to accommodate both near and far-field imaging, as desired.

The scan engine 100 may additionally include an illumination assembly 170 at least partially disposed within the confined volume 104a of the chassis 102. The illumination assembly 170 is operatively coupled to the first board 110 (via, for example, the component mounting portions 118) on the first side 110a thereof and is disposed to illuminate objects in the FOV of the imaging assembly 140. The illumination assembly 170 includes an illumination source 173 disposed on the first circuit board 110. The illumination source 173 may include a single light emitting diode (LED) or light source, or may include multiple LEDs or light sources to provide the illumination along any number of illumination axes. While described as using LEDs to provide the illumination, the illumination source 173 may alternatively, or additionally, include one or more laser diodes (LDs), black body radiation sources, incandescent sources, or another light source to provide radiation along desired illumination axes.

The illumination assembly 170 may further include additional components such as, for example, illumination optics that provide the illumination to the FOV of the scan engine 100. The illumination assembly 170 may further include a collimator that collimates the illumination light provided by the illumination source 173. An optical element may be provided in the form of a substrate that includes a transparent window at one region of the dual optical element, and a microlens array (MLA) disposed at another region of the dual optical element, with the regions of the transparent window and MLA disposed adjacent to each other. The transparent window may be a material or aperture that allows light to propagate through the transparent window without altering the axis of propagation of the light, or change a focus of the light propagating through the transparent window.

The scan engine 100 may further include an aiming assembly 150 that is at least partially disposed within the confined volume 104a of the chassis 102. The aiming assembly 150 may include an aiming source in the form of a laser diode 152 disposed within the confined volume 104a and being electrically coupled with the second circuit board 130. The laser diode 152 is configured to generate an aiming pattern or light to assist with identifying the imaging FOV along an aiming axis. Various optics are disposed along the aiming axis to manipulate the aiming light as the light propagates through the confined volume 104a of the chassis 102.

The laser diode 152 may include any number of leads 153 coupled therewith. As illustrated in FIGS. 2 and 4, these leads 153 extend through the opening or pass-through region 111 of the first board 110 to the second board 130, where they may be secured therewith using any number of suitable approaches such as, for example, soldering or other coupling mechanisms. Such a coupling between the leads 153 and the second circuit board 130 allows components of the second circuit board 130 to drive or otherwise operate the laser diode 152 to generate the aiming pattern. In some examples, the leads 153 may also be soldered to a portion of the first circuit board 110 to provide additional strength and/or stability. As previously noted, because the laser diode 152 provided for use with the scan engine 100 is a green laser diode, a laser drive circuit 156 may be provided in the form of capacitors, resistors, transistors, power supplies, etc. Such components may be disposed on the second board 130 to provide safety and fault detection capabilities. This drive circuit 156 may be electrically coupled with the laser diode 152.

An aiming diffractive optical element (DOE) in the form of a pattern generator 158 is disposed within the confined volume 104a of the first chassis 102 to manipulate the aiming light to form the aiming pattern. The aiming pattern generator 158 may be a diffractive optical element, or a refractive optical element for forming the aiming pattern. Coupling the laser diode 152 with the second board 130 allows for spacing of the various electrical systems (e.g., the imaging assembly 140, the illumination assembly 170, and the aiming assembly 150 having additional circuitry) while occupying the same vertical footprint within the scan engine 100, thus reducing its overall size.

As previously mentioned, the first and second circuit boards 110, 130 are electrically and communicatively coupled via the first board connector 114 and the second board connector 135. The processor 117, which in the illustrated examples is operably coupled with the first circuit board 110, may communicate with, drive, or otherwise operate the components and assemblies carried by the first circuit board 110, and additionally may communicate with, drive, or otherwise operate the components and assemblies carried by the second circuit board 130 by transmitting signals via the first and second circuit board connectors 114, 135.

So arranged, the scan engine 100 described herein may be alternately adaptable with different aiming assemblies using different laser drive systems as desired. More specifically, the scan engine 100 may allow for swapping out the second circuit board 130 and aiming assembly 150 with a different second circuit board (not illustrated) having a different aiming assembly (not illustrated) coupled therewith. As an example, the different second circuit board may incorporate a laser diode outputting a different wavelength of light (e.g., a red laser), or may have multiple laser diodes coupled therewith. In yet other examples, the second circuit board 130 and the aiming assembly 150 coupled therewith may alternately be coupled with a different first circuit board (not illustrated) having a second imaging sensor (not illustrated) having a different configuration than the imaging sensor 144 described above.

It is to be appreciated that in some examples, the scan engine 100 may include any number of additional features to assist with operation thereof. More specifically, in some examples, the second board 130 may additionally include a second board-to-host controller 136. This second board-to-host controller 136 may be electrically coupled with an additional circuit board (not illustrated) to provide a connection with a host board to provide a scan engine capable of decoding the images.

So arranged, the scan engine 100 described herein advantageously separates the aiming assembly (i.e., the laser drive circuit) from the other circuit board including componentry for the imaging and illumination assemblies. Such an arrangement provides for greater freedom in terms of circuit design and real estate for implementing laser drive. Additionally, by incorporating a green laser diode, the aiming assembly may produce brighter light that is easier to see and highlight the FOV, resulting in improved eye response.

The scan engine 100 described herein may also advantageously provide improved heat dissipation due to the gap between the first and second circuit boards. Additionally, in implementations where the chassis is constructed from a metallic material, heat generated by the first and/or the second boards may be dissipated through the chassis. In some arrangements, a temperature measurement device may be provided that ensures the scan engine 100 is operating within safe temperature parameters.

The scan engine 100 described herein is further advantageously modular in the sense that various boards may be used with various imaging engines where the laser drive has its own separate circuit that interfaces with the remainder of the engine. Either of the first or the second boards may be modularly implemented across a range of scan engines having different characteristics.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions.

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device”can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

The claims are:

1. A scan engine for capturing at least one image of an object appearing in an imaging field of view (FOV), comprising:
a chassis including a chassis body defining at least one confined volume, the chassis body including a chassis mounting portion;
a first board operably coupled with the chassis body via the chassis mounting portion, the first board including a first board connector disposed thereon;
a second board including a second board connector disposed thereon adapted to couple with the first board connector of the first board;
an imaging assembly including an imaging sensor adapted to capture the at least one image of the object appearing in the imaging FOV, the imaging assembly being at least partially disposed within the at least one confined volume of the chassis body; and
an aiming assembly adapted to generate an aiming pattern to assist with identifying the imaging FOV, the aiming assembly including a laser diode at least partially disposed within the at least one confined volume of the body;
wherein the imaging sensor is adapted to be electrically coupled with the first board, and the laser diode is adapted to be electrically coupled with the second board.

2. The scan engine of claim 1, wherein the second board is adapted to physically couple with the first board in a stacking arrangement.

3. The scan engine of claim 1, wherein the aiming assembly further includes a laser drive circuit disposed on the second board, the laser drive circuit adapted to electrically couple with the laser diode.

4. The scan engine of claim 3, wherein the laser diode includes at least one lead extending therefrom, the at least one lead adapted to electrically couple with the laser drive circuit.

5. The scan engine of claim 4, wherein the at least one lead is adapted to extend through at least one opening formed on the first board.

6. The scan engine of claim 1, further including an illumination assembly.

7. The scan engine of claim 1, further including a processor disposed on the first board, the processor adapted to control operation of the imaging assembly and further being adapted to send a control signal to the second board via the first board connector to control operation of the aiming assembly.

8. The scan engine of claim 1, wherein the second board further includes a second board-to-host connector adapted to electrically couple with a host controller.

9. The scan engine of claim 1, wherein the second board further includes support circuitry adapted to control operation of the aiming assembly.

10. A scan engine for capturing at least one image of an object appearing in an imaging field of view (FOV), comprising:
a chassis including a chassis body defining at least one confined volume, the chassis body including a chassis mounting portion;
a first board having a first side and a second side, the first side being operably coupled with the chassis, the first board including a first board connector disposed on the second side thereof;
a second board having a first side and a second side, the second board including a second board connector disposed on the first side thereof adapted to electrically couple with the first board connector of the first board;
an imaging assembly including an imaging sensor adapted to capture the at least one image of the object appearing in the imaging FOV, the imaging assembly being at least partially disposed within the at least one confined volume of the chassis body, the imaging sensor being electrically coupled with the first board; and
an aiming assembly adapted to generate an aiming pattern to assist with identifying the FOV, the aiming assembly including a laser diode extending along a longitudinal axis in a first direction and being at least partially disposed within the at least one confined volume of the chassis body, the laser diode being electrically coupled with the second board.

11. The scan engine of claim 10, wherein the laser diode includes at least one lead extending through the first board to the second board to be electrically coupled therewith.

12. The scan engine of claim 11, wherein the at least one lead is soldered to at least one of first board or the second board.

13. The scan engine of claim 10, wherein the aiming assembly further includes a laser drive circuit at least partially disposed on the first side of second board, the laser drive circuit adapted to electrically couple with the laser diode.

14. The scan engine of claim 10, further including an imaging assembly adapted to be at least partially disposed within the chassis body, the imaging assembly at least partially disposed on the first side of the first board.

15. The scan engine of claim 10, further comprising a processor at least partially disposed on the first board, the processor adapted to send a control signal to the second board via the first board connector to control operation of the aiming assembly.

16. The scan engine of claim 10, wherein the second board further includes a second board-to-host connector disposed on the second side of the second board, the second board-to-host connector adapted to electrically couple with a host controller.

17. A scan engine for capturing at least one image of an object appearing in an imaging field of view (FOV), comprising:
a chassis including a chassis body defining at least one confined volume, the chassis body including a chassis mounting portion;
a second board including a second board connector adapted to be alternatively connected with: 1) a first primary board having a first imaging sensor coupled therewith; and 2) a second primary board having a second imaging sensor coupled therewith, the first imaging sensor having a different configuration than the second imaging sensor.

18. A scan engine for capturing at least one image of an object appearing in an imaging field of view (FOV), comprising:
a chassis including a chassis body defining at least one confined volume, the chassis body including a chassis mounting portion;
a first board coupled with the chassis at the chassis mounting portion, the first board including an imaging system at least partially disposed within the chassis body and coupled with the first board, the imaging system adapted to capture at least one image of an object appearing in the FOV of the device, the first circuit board being alternatively couplable with:
a first secondary board having a first laser diode and first laser drive circuit electrically coupled therewith, the first laser diode outputting a first wavelength of light, and
a second secondary board having a second laser diode and second laser drive circuit electrically coupled therewith, the second laser diode outputting a second wavelength of light.

19. The scan engine of claim 18, wherein the first board includes an opening to allow a respective first laser lead of the first laser diode and a second laser lead of the second laser diode to extend therethrough.

20. The scan engine of claim 18, wherein the first secondary board and the second secondary board are adapted to selectively physically couple with the first board in a stacking arrangement.
